(19) United States
(12) Patent Application Publication
(10) Pub. No.: US 2005/0270731 A1
(43) Pub. Date: Dec. 8, 2005

(54) Computer docking system

(76) Inventor: Memphis-Zhihong Yin, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/862,526

(22) Filed: Jun. 7, 2004

(51) Int. Cl. G06F 1/16

(52) U.S. Cl. 361/681

(57) ABSTRACT

A computer docking system comprises a docking bracket adapted to support a display device. The docking bracket is also adapted to support vertical docking of a portable computer device adjacent the display device.

### BACKGROUND

A docking system is generally an interface for removably and electrically coupling a portable computer device, such as a laptop or notebook computer, to other computer devices such as a desktop computer, keyboard, mouse, printer, and/or display device. Thus, the portable computer device may be used independently or in conjunction with a variety of types of other computer devices. However, using the portable computer device with other computer devices via a docking station generally results in a shortage of available workspace.

### SUMMARY OF THE INVENTION

In accordance with one embodiment of the present invention, a computer docking system comprises a docking bracket adapted to support a display device. The docking bracket is also adapted to support vertical docking of a portable computer device adjacent the display device.

In accordance with another embodiment of the present invention, a computer docking system comprises a docking bracket adapted to support vertical docking of a portable computer device. The docking bracket also comprises an adjustable support member for varying a size of a docking space for the portable computer device.

In accordance with another embodiment of the present invention, a computer docking system comprises a docking bracket adapted to support vertical docking of a portable computer device. The docking bracket also comprises a display member adapted to enable viewing of a display device of the portable computer device while the portable computer device is docked in the docking bracket.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a computer docking system in accordance with the present invention;

FIG. 2 is a diagram illustrating another view of the computer docking system illustrated in FIG. 1;

FIG. 3 is an exploded diagram illustrating an embodiment of the computer docking system illustrated in FIG. 1; and

FIG. 4 is a diagram illustrating another embodiment of a computer docking system in accordance with the present invention.

### DETAILED DESCRIPTION OF THE DRAWINGS

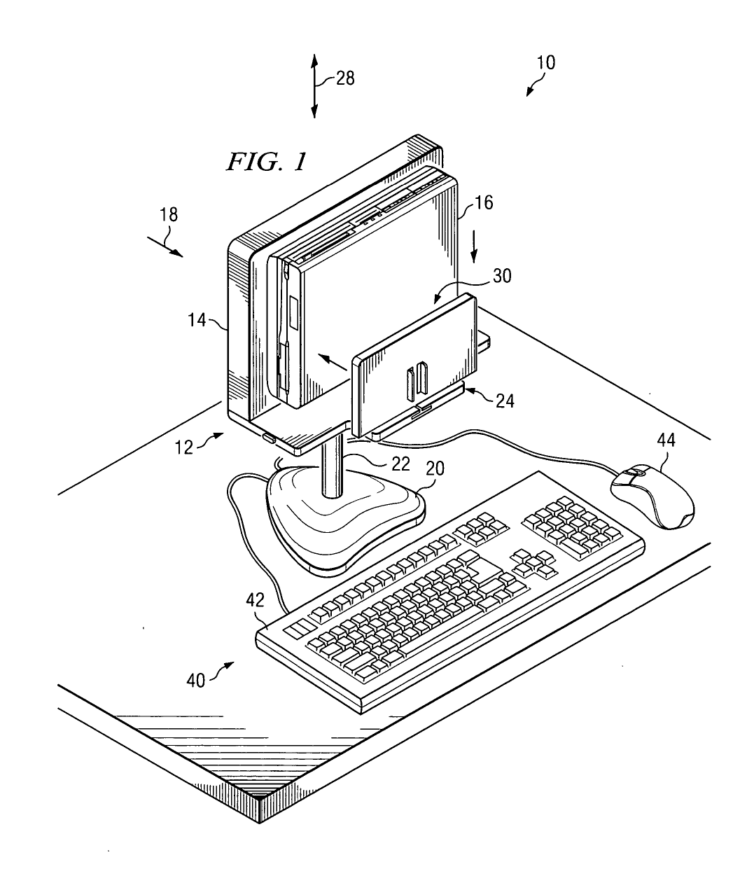

The preferred embodiments of the present invention and the advantages thereof are best understood by referring to FIGS. 1-4 of the drawings, like numerals being used for like and corresponding parts of the various drawings.

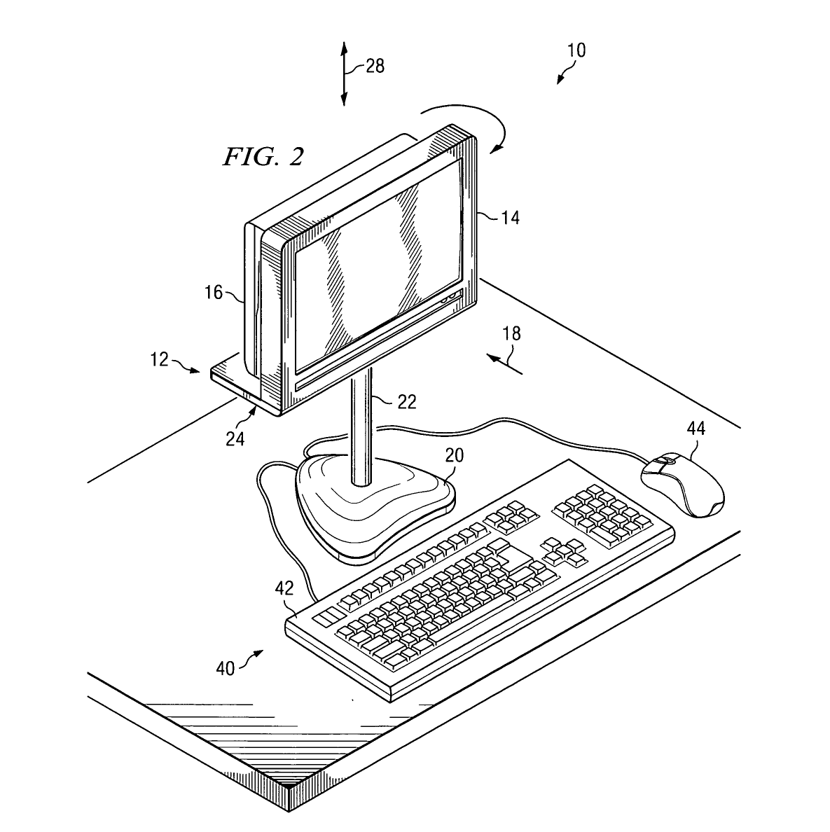

FIG. 1 is a diagram illustrating an embodiment of a docking system 10 in accordance with the present invention, and FIG. 2 is a diagram illustrating another view of docking system 10 illustrated in FIG. 1. In the embodiment illustrated in FIGS. 1 and 2, docking system 10 comprises a docking bracket 12 adapted to support a display device 14 and a vertically docked portable computer device 16. For example, in the embodiment illustrated in FIGS. 1 and 2, portable computer device 16 is vertically docked adjacent display device 14 and rearwardly of display device 14 relative to a viewing direction of display device 14, indicated generally at 18. Display device 14 may comprise any type of device for displaying image content to a user such as, but not limited to, a liquid crystal display (LCD). Portable computer device 16 may comprise any type of portable computing device such as, but not limited to, a notebook or laptop computer, tablet personal computer, or other type of portable computing device.

In the embodiment illustrated in FIGS. 1 and 2, docking bracket 12 comprises a base member 20, a pedestal 22, and a support bracket assembly 24. In the embodiment illustrated in FIGS. 1 and 2, docking bracket 12 is configured to enable a user to rotate docking bracket 12 about a vertical axis 28 to enable convenient access to a docking space 30 of docking bracket 12 for portable computer device 16. For example, in the embodiment illustrated in FIGS. 1 and 2, docking bracket 12 is rotatable about axis 28 perpendicular (i.e., perpendicular or substantially perpendicular) relative to viewing direction 18 to enable convenient access to docking space 30. In the embodiment illustrated in FIGS. 1 and 2, support bracket assembly 24 is rotatably coupled to pedestal 22 to enable rotational movement of support bracket assembly 24 about axis 28 relative to pedestal 22. However, it should be understood that docking bracket 12 may be otherwise configured to enable rotational movement of support bracket assembly 24 to enable user access to docking space 30. For example, docking bracket 12 may also be configured such that support bracket assembly 24 is fixedly coupled to pedestal 22, and pedestal 22 is rotationally coupled to base member 20. It should also be understood that base member 20 and pedestal 22 may be configured as a single component of docking bracket 12.

In the embodiment illustrated in FIGS. 1 and 2, docking bracket 12 is also configured to enable communicative coupling of a peripheral device 40 to display device 14 and/or portable computer device 16. For example, in the embodiment illustrated in FIGS. 1 and 2, peripheral devices 40 such as a keyboard 42, a mouse 44, and any other type of peripheral device 40 may be communicatively coupled to display device 14 and/or portable computer device 16 via base member 20 as described further below. It should also be understood that system 10 may be configured to support wireless communications between peripheral device(s) 40, display device 14 and/or portable computer device 16.

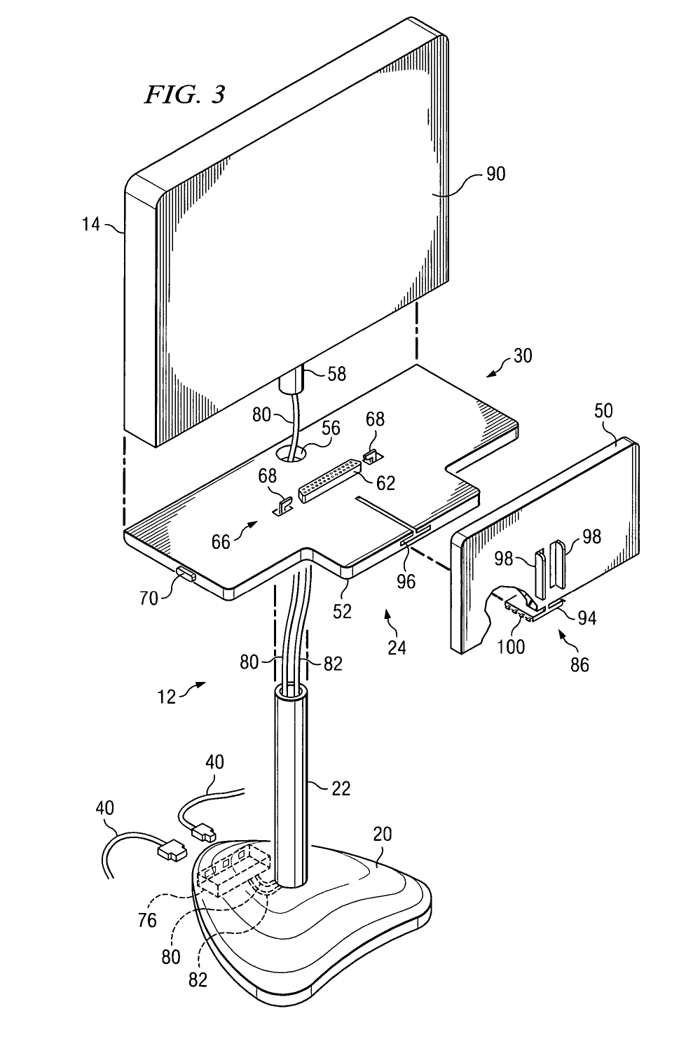

FIG. 3 is an exploded diagram illustrating an embodiment of docking system 10 in accordance with the present invention. In the embodiment illustrated in FIG. 3, support bracket assembly 24 comprises a vertical support member 50 and a horizontal support member 52. In the embodiment illustrated in FIG. 3, horizontal support member 52 comprises an opening 56 adapted to support releasable engagement of display device 14 with support member 52 via a vertical post member 58 of display device 14. However, it should be understood that display device 14 may be otherwise coupled to support bracket assembly 24 in a fixed or releasable manner.

In the embodiment illustrated in FIG. 3, docking bracket 12 comprises a docking connector 62 for engaging a corresponding connector of portable computer device 16. In FIG. 3, a single docking connector 62 is illustrated; however, it should be understood that a greater quantity of docking connectors 62 may be used. In the embodiment illustrated in FIG. 3, docking connector 62 is coupled to horizontal support member 52 to enable engagement of docking connector 62 with a corresponding connector disposed on a rearward surface of portable computer device 16. However, it should be understood that docking connector 62 may be otherwise located on docking bracket 12 to engage a corresponding connector of portable computer device 16 to facilitate communications between portable computer device 16 and peripheral device(s) 40 and/or display device 14. However, it should also be understood that docking bracket 12 may be configured without connector 62 (e.g., wireless communications) or be configured for both wired and wireless communications.

In the embodiment illustrated in FIG. 3, docking bracket 12 also comprises a locking element 66 adapted to releasably engage portable computer device 16 to secure portable computer device 16 to docking bracket 12. In the embodiment illustrated in FIG. 3, locking element 66 comprises a pair of oppositely disposed retractable clips 68 for releasably engaging a portion of portable computer device 16. For example, in operation, clips 68 may be actuated via a push-button mechanism 70 to cause inward and outward movement of clips 68 to correspondingly engage and disengage portable computer device 16. However, it should be understood that other devices or methods may be used to releasably secure portable computer device 16 to docking bracket 12. However, it should also be understood that docking bracket 12 may be configured without locking element 66.

In the embodiment illustrated in FIG. 3, docking bracket 12 comprises a connector assembly 76 disposed in base member 20 and adapted to enable communicative coupling of peripheral devices 40 to display device 14 and/or portable computer device 16. Connector assembly 76 also facilitates communicative coupling of portable computer device 16 to display device 14. For example, as illustrated in FIG. 3, display device 14 and docking connector 62 are communicatively coupled to connector assembly 76 via cables 80 and 82, respectively, thereby facilitating communications between display device 14, portable computer device 16, and/or peripheral devices 40. However, it should be understood that connector assembly 76 may be otherwise located on docking bracket 12. Further, for wireless communication applications, for example, docking bracket 12 may be configured without connector assembly 76.

In the embodiment illustrated in FIG. 3, bracket assembly 24 comprises an adjustable vertical support member 50 to enable dimensional or size changes to docking space 30 to accommodate different sizes of portable computer devices 16. For example, in the embodiment illustrated in FIG. 3, vertical support member 50 comprises an adjustment element 86 adapted to releasably engage horizontal support member 52 to facilitate variable placement of vertical support member 50 relative to a rearward surface 90 of display device 14. In the embodiment illustrated in FIG. 3, adjustment element 86 comprises a locking tab 94 adapted to cooperate with a T-shaped channel 96 formed in horizontal support member 52 and a pair of oppositely disposed release members 98 actuatable by a user to engage and disengage horizontal support member 52. Thus, in operation, a user may adjust a size of docking space 30 by translating vertical support member 50 relative to display device 14 using adjustment element 86. For example, release members 98 are coupled to locking tab 94 such that retaining elements 100 on locking tab 94 extend and retract relative to complementary structure formed within channel 96 to facilitate releasably securing vertical support member 50 at various locations relative to rearward surface 90 of display device 14, thereby accommodating various sizes of portable computer devices 16.

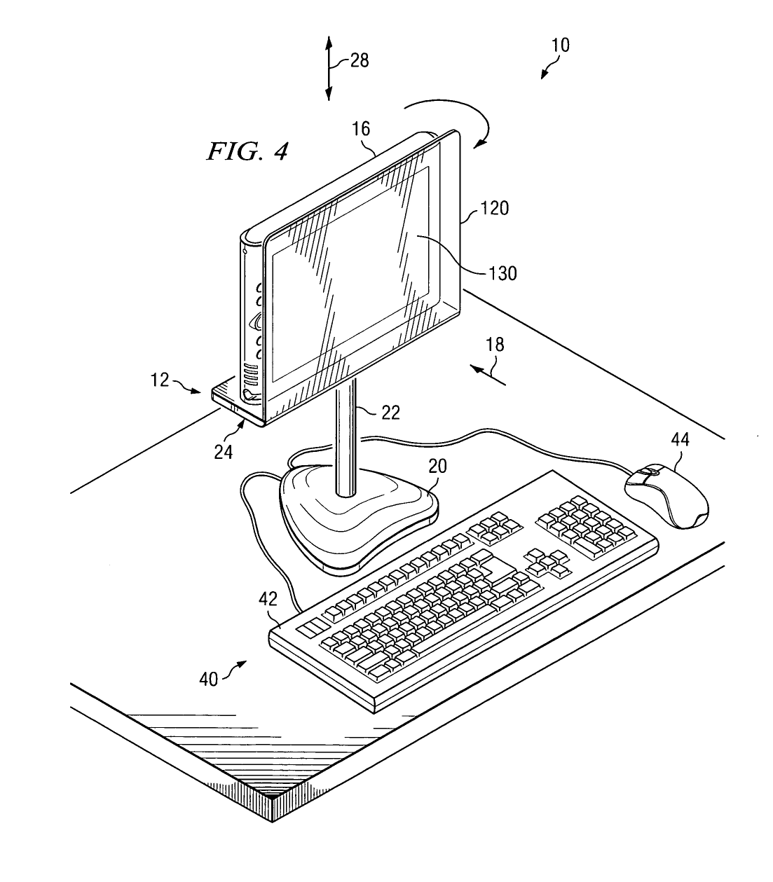

FIG. 4 is a diagram illustrating another embodiment of docking system 10 in accordance with the present invention. In the embodiment illustrated in FIG. 4, docking bracket 12 comprises base member 20, pedestal 22, support bracket assembly 24 and a display member 120. Display member 120 is configured to enable a user of docking bracket 12 to view a display device 130 of portable computer device 16. For example, in FIG. 4, portable computer device 16 is illustrated as a tablet computer device having its own display device 130. Thus, display member 120 may be configured to be transparent or semi-transparent to enable a user of docking bracket 12 to view display device 130 of portable computer device 16. Display member 120 also provides stability for portable computer device 16 by retaining portable computer device 16 within docking space 30 and thereby preventing inadvertent or undesired movement of portable computer device 16 (e.g., preventing portable computer device 16 from falling from docking bracket 12).

Thus, in operation, a user may rotate docking bracket 12 about axis 28 relative to a viewing direction 18 to obtain convenient access to docking space 30 for disposing or otherwise inserting portable computer device 16 into docking space 30. The user may then rotate docking bracket 12 about axis 28 to a desired position to enable viewing of display device 130 of portable computer device 16 via display member 120. As described above, support bracket assembly 24 may be used to vary a size of docking space 30 to accommodate a variety of sizes of portable computer devices 16. Additionally, as described above, one or more peripheral devices 40 may be communicatively coupled to portable computer device 16.

Thus, embodiments of the present invention enable convenient docking of portable computer devices 16 of varying sizes. Additionally, embodiments of the present invention enable convenient access to a docking area for portable computer devices 16. For example, embodiments of the present invention enable a user to easily rotate docking bracket 12 to access docking space 30 for portable device 16 insertion and, after insertion of portable computer device 16 into docking space 30, rotate docking bracket 12 to accommodate viewing of display device 14 or a display device 130 of the portable computer device 16.

1. A computer docking system, comprising:
a docking bracket adapted to support a display device, the docking bracket adapted to support vertical docking of a portable computer device adjacent the display device, the docking bracket adapted to vary a dimension of a docking space relative to a rearward surface of the display device for receiving the portable computer device.

2. The system of claim 1, the docking bracket comprising a rotatable docking bracket.

3. The system of claim 1, wherein the docking bracket is adapted to communicatively couple the portable computer device to the display device.

4. The system of claim 1, further comprising a locking element adapted to removably secure the portable computer device to the docking bracket.

5. The system of claim 1, wherein the docking bracket is adapted to communicatively couple the portable computer device to at least one peripheral device.

6. The system of claim 1, wherein the docking bracket comprises a base member adapted to communicatively couple at least one peripheral device to the portable computer device.

7. The system of claim 1, further comprising at least one docking connector coupled to the docking bracket and adapted to communicatively engage the portable computer device.

8. The system of claim 1, wherein the docking bracket is adapted to support the portable computer device on a side of the display device opposite a viewing direction relative to the display device.

9. The system of claim 1, wherein the docking bracket comprises a vertical support member spaced apart from a rearward surface of the display device.

10. (canceled)

11. The system of claim 1, wherein the docking bracket comprises an adjustable vertical support member adapted to vary the dimension of the docking space.

12. A computer docking system, comprising:
means for supporting a display device;
means for vertically supporting a portable computer device adjacent the display device; and
means for varying a dimension of a docking space relative to a rearward surface of the display device for receiving the portable computer device.

13. The system of claim 12, further comprising means for communicatively coupling the portable computer device to the display device.

14. The system of claim 12, further comprising means for enabling rotation of the means for supporting the display device relative to a user.

15. (canceled)

16. The system of claim 12, further comprising means for communicatively coupling the portable computer device to at least one peripheral device.

17. A computer docking system, comprising:
a docking bracket adapted to support docking of a portable computer device, the docking bracket having an adjustable support member for varying a size of a docking space for docking the portable computer device.

18. The system of claim 17, wherein the docking bracket is adapted to communicatively couple the portable computer device to at least one peripheral device.

19. The system of claim 17, wherein the docking bracket is adapted to communicatively couple the portable computer device to a display device.

20. The system of claim 17, wherein the docking bracket is rotatably coupled to a base member.

21. The system of claim 17, wherein the docking bracket is adapted to support a display device.

22. The system of claim 17, wherein the docking bracket comprises a locking element adapted to removably secure the portable computer device to the docking bracket.

23. A computer docking system, comprising:
a docking bracket adapted to support a portable computer device and a display device, the docking bracket rotatable about an axis perpendicular to a viewing direction relative to the display device the docking bracket adapted to vary a size of a docking space for docking the portable computer device.

24. The system of claim 23, the docking bracket rotatably coupled to a base member.

25. The system of claim 23, the docking bracket adapted to support vertical docking of the portable computer device adjacent the display device.

26. The system of claim 23, the support member adapted to vary the size of the docking space for receiving the portable computer device based on a size of the portable computer device.

27. The system of claim 23, the docking bracket adapted to communicatively couple the display device to the portable computer device.

28. The system of claim 23, the docking bracket adapted to communicatively couple the portable computer device to at least one peripheral device.

29. The system of claim 23, the portable computer device disposed on a side of the display device opposite the viewing direction.

30. A computer docking system, comprising:
a docking bracket adapted to support vertical docking of a portable computer device, the docking bracket having a display member adapted to enable viewing of a display device of the portable computer device while the portable computer device is docked in the docking bracket, the docking bracket adapted to vary size of a docking space for docking the portable computer device.

31. The system of claim 30, the docking bracket comprising a rotatable docking bracket.

32. The system of claim 30, the docking bracket rotatable about an axis perpendicular to a viewing direction of the display device.

33. The system of claim 30, wherein the docking bracket is adapted to vary the size of the docking space for the portable computer device based on a size of the portable computer device.

34. The system of claim 30, the docking bracket adapted to communicatively couple the portable computer device to at least one peripheral device.

35. The system of claim 30, the docking bracket comprising a locking element adapted to removably secure the portable computer device to the docking bracket.

36. The system of claim 30, the docking bracket comprising at least one docking connector adapted to communicatively engage the portable computer device.

37. The system of claim 30, the docking bracket comprising a base member adapted to communicatively couple at least one peripheral device to the portable computer device.

38. The computer docking system of claim 17, the support member adapted to vary the size of the docking space to accommodate a different size of the portable computer device.
